(19) United States
(12) Patent Application Publication
(10) Pub. No.: US 2024/0237650 A1
(43) Pub. Date: Jul. 18, 2024

(54) AQUEOUS FUNGICIDE MIXTURE FORMULATION

(71) Applicant: ADAMA MAKHTESHIM LTD., Beer Sheva (IL)

(72) Inventors: Yadagani VENKATESWARARAO, Telangana (IN); Arunagirinathan Manickam ADHIMOOLAM, Tamil Nadu (IN)

(73) Assignee: ADAMA MAKHTESHIM LTD., Beer Sheva (IL)

(21) Appl. No.: 18/579,894

(22) PCT Filed: Jul. 17, 2022
(86) PCT No.: PCT/IL2022/050769

§ 371 Date: Jan. 17, 2024

(30) Foreign Application Priority Data
Jul. 17, 2021 (IN) 202111032249

(51) Int. Cl. A01N 43/54; A01N 25/30; A01N 43/653; A01N 43/80; A01N 47/02; A01N 47/20; A01P 1/00; A01P 3/00

(52) U.S. Cl. CPC A01N 43/54; A01N 25/30; A01N 43/653; A01N 43/80; A01N 47/02; A01N 47/20; A01P 1/00; A01P 3/00

(57) ABSTRACT

The present invention relates to a stable aqueous fungicide mixture formulation comprising a phthalimide fungicide selected from the group consisting of folpet, captan and any combination thereof and an additional fungicide selected from the group comprising a strobilurin fungicide, a triazole fungicide and any combination thereof, and to methods for controlling or preventing fungal diseases in crop plants.

### FIELD OF INVENTION

The present invention relates to a stable aqueous fungicide mixture formulation comprising a phthalimide fungicide selected from the group consisting of folpet, captan and any combination thereof and an additional fungicide selected from the group comprising a strobilurin fungicide, a triazole fungicide and any combination thereof, and to methods for controlling or preventing fungal diseases in crop plants. This invention provides a novel stable aqueous fungicide mixture formulation comprising one phthalimide fungicide selected from the group consisting of folpet, captan and any combination thereof and an additional fungicide, for increasing the desirable bioavailability and better penetration through hydrophobic actives' colocalization, thereby enhancing efficiency.

### BACKGROUND OF INVENTION

Fungicides are the classes of compounds of natural or synthetic origin which act to protect plants against damage caused by various fungi. Despite the benefits derived from the use of fungicides in agriculture such as protection of crops and improved productivity, it is always desirable to reduce the amount of fungicides used in the fields owing to the potential health risks associated with an intensive use of agrochemicals. Another important issue associated with fungi attacks is the loss of nutrients which leads to a decrease in the overall yield of the crop. Formulations comprising one single active ingredient have shown a limited control over diseases.

The vulnerability of crops to fungal infection makes fungi control one of the major management components of the total crop production system. Fungi are very destructive to crop plants and can significantly reduce crop yields and quality. Fungicides help minimize this damage by controlling various fungi. Many known fungicides are effective for specific crops and have a limited activity. In addition, a resistance is developed and there is a need to restore, increase and/or extend the activity.

Fungicide mixture formulations are typically used to broaden spectrum of control, to minimize the doses of chemicals used, to retard resistance development and to reduce the cost of the treatment through additive as well as synergistic effect. Although many mixture formulations of fungicidal agents have been studied, the challenge remains to prepare a stable and efficient aqueous formulation of a mixture of two or more hydrophobic actives with good colocalization. In the absence of localization of actives, the efficiency of formulation is said to be not well pronounced.

The subject matter of the present invention is aqueous fungicide mixture formulations comprising two or more hydrophobic actives, namely one phthalimide fungicide selected from the group consisting of folpet, captan and any combination thereof and an additional fungicide selected from the group comprising a strobilurin fungicide such as azoxystrobin, pyraclostrobin, picoxystrobin, and a triazole fungicide such as tebuconazole, prothioconazole, difenoconazole and any combination thereof.

Phthalimide is an imido derivative of phthalic acid. In organic chemistry, imide is a functional group consisting of two carbonyl groups bound to nitrogen. They are hydrophobic and neutral and can therefore cross biological membranes in vivo. Phthalimide fungicides such as captan and folpet are multi-site inhibitors that affect energy production.

The strobilurin fungicides are extremely useful in controlling a broad spectrum of common vegetable pathogens. All strobilurin fungicides inhibit fungal respiration by binding to the cytochrome b complex III at the Q₀ site in mitochondrial respiration. The fungicide works by inhibiting the fungi's ability undergo normal respiration. The strobilurin chemistries have a very specific target site. Azoxystrobin, a strobilurin fungicide, has IUPAC name of methyl (E)-2-{2[6-(2-cyanophenoxy)pyrimidin-4-yloxy]phenyl}-3-methoxyacrylate. This carboxylic acid methyl ester has the molecular formula of C₂₂H₁₇N₃O₅ and the molecular mass of 403.4 gmol⁻¹. Azoxystrobin retains the methyl β-methoxyacrylate group of the naturally-occurring strobilurins, which characterizes its structure:

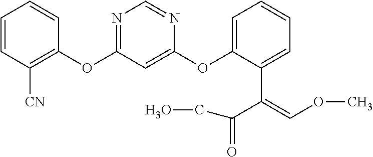 [SMILES: CO/C=C(/C(=O)CO)c1ccccc1Oc1cc(Oc2ccccc2C#N)ncn1]

The molecule of azoxystrobin also has a large hydrophobic moiety of three aromatic rings: a cyanophenyl ring, a pyrimidinyl ring, and a phenylacrylate ring. At 20° C., the solubility of azoxystrobin in water is 6.7 mg L⁻¹ (pH 5.2 and 7.0) and 5.9 mg L⁻¹ (pH 9.2), which make this active reasonably hydrophobic.

Triazole fungicides are widely used as broad-spectrum fungicides, non-steroidal antiestrogens and for various industrial applications. The increasingly reported toxicity incidents have led triazole fungicides as emerging contaminants of environmental and public health concern. However, whether triazole fungicides behave as endocrine disruptors by directly mimicking environmental androgens/antiandrogens or exerting potential androgenic disruption indirectly through the inhibition of cytochrome P450 (CYP450) enzyme activity is yet an unresolved question. Few commonly used triazole fungicides includes tebuconazole, prothioconazole and difenoconazole for the androgenic and anti-androgenic activity.

The aqueous fungicide mixture formulations comprising Azoxystrobin and a phthalimide fungicide, such as, folpet is already known in the art. The CN 102150671 patent, assigned to Nutrichem International, discloses formulations comprising azoxystrobin and folpet with synergistic effect, which are useful for preventing and controlling fungi-induced plant diseases. Furthermore, CN 102669131 publication describes fungicidal suspension concentrate formulation containing azoxystrobin and folpet.

However, no prior art has ever addressed the problem of insufficient colocalization of hydrophobic actives, such as phthalimide and strobilurin in an aqueous fungicide mixture formulation, which is key to the efficiency of formulation regarding both efficacy as well as stability. The meticulous choice of suitable inert components or coformulants in the formulation may result in surprising outcome to the efficiency of the said formulation.

The inert components or coformulants of a formulation must be chosen to bring crop protection active compounds, for example, hydrophobic fungicide actives, into such a formulation that the end user can apply them either as such or after dilution with water. The correct choice of suitable inert components in the formulation often determines to a significant extent whether the active ingredient can display its full efficacy after application. When selecting suitable components to ensure the physicochemical stability and effectiveness of the formulation to the highest extent, it is necessary to be aware of the physico-chemical interactions of the inert components among themselves within the formulation. There is a need to develop a highly physically stable formulation with suitable inert components, which has high stability during the preparation, storage and application process of the formulation.

In light of the above, there is endeavor in the present invention for a novel stable aqueous fungicide mixture formulation with suitable inert components therein, comprising a phthalimide fungicide selected from the group consisting of folpet, captan and any combination thereof and an additional fungicide selected from the group comprising a strobilurin fungicide, a triazole fungicide and any combination thereof, for increasing the desirable bioavailability and better penetration through hydrophobic actives' colocalization, thereby enhancing efficiency.

### SUMMARY OF THE PRESENT SUBJECT MATTER

We have reasonably addressed the challenges as described above as a whole or in part by arriving at a novel aqueous fungicide mixture formulation with suitable inert components therein, as defined below.

The present invention relates to an aqueous fungicide mixture formulation comprising (a) an effective amount of a phthalimide fungicide selected from the group consisting of folpet, captan and any combination thereof; (b) an effective amount of an additional fungicide selected from the group comprising a strobilurin fungicide, a triazole fungicide and any combination thereof; (c) an effective amount of a non-ionic surfactant; (d) an effective amount of an amine capable of forming clathrate hydrates; and (c) an effective amount of a pH modifier.

The present invention also provides an aqueous fungicide mixture formulation comprising (a) an effective amount of a phthalimide fungicide selected from the group consisting of folpet, captan and any combination thereof; (b) an effective amount of an additional fungicide selected from the group comprising a strobilurin fungicide, a triazole fungicide and any combination thereof; (c) an effective amount of a non-ionic surfactant; (d) an effective amount of an amine capable of forming clathrate hydrates; and (e) an effective amount of a pH modifier; which further comprises agriculturally acceptable carriers, such as a stabilizer, a wetting agent, a defoamer, an anti-freezing agent, a biocide, a defoamer and a rheology modifier.

The present invention relates to an aqueous fungicide mixture formulation comprising (a) an effective amount of a phthalimide fungicide selected from the group consisting of folpet, captan and any combination thereof; (b) an effective amount of a strobilurin fungicide selected from the group comprising azoxystrobin, pyraclostrobin and picoxystrobin; (c) an effective amount of a non-ionic surfactant; (d) an effective amount of an amine capable of forming clathrate hydrates; and (c) an effective amount of a pH modifier.

The present invention also relates to an aqueous fungicide mixture formulation comprising (a) an effective amount of a phthalimide fungicide selected from the group consisting of folpet, captan and any combination thereof; (b) an effective amount of a triazole fungicide selected from the group comprising tebuconazole, prothioconazole and difenoconazole; (c) an effective amount of a non-ionic surfactant; (d) an effective amount of an amine capable of forming clathrate hydrates; and (c) an effective amount of a pH modifier.

The present invention relates to an aqueous fungicide mixture formulation comprising (a) an effective amount of folpet; (b) an effective amount of azoxystrobin; (c) an effective amount of a non-ionic surfactant; (d) an effective amount of an amine capable of forming clathrate hydrates; and (c) an effective amount of a pH modifier.

The present invention also relates to an aqueous fungicide mixture formulation comprising (a) an effective amount of folpet; (b) an effective amount of azoxystrobin; (c) an effective amount of a non-ionic surfactant selected from a group comprising an alkyl end-capped alcohol ethoxylate, a fatty-amide ethoxylate, a sugar amide ethoxylate; (d) an effective amount of an amine capable of forming clathrate hydrates selected from a group comprising hexamine, quaternary hexamine, urea, alkyl urea, amine, polyamine, polyethylenimine, alkylamide and a sugar amide; and (c) an effective amount of a pH modifier.

The present invention further relates to an aqueous fungicide mixture formulation comprising (a) an effective amount of folpet; (b) an effective amount of azoxystrobin; (c) an effective amount of an alkyl end-capped alcohol ethoxylate; (d) an effective amount of hexamine; and (c) an effective amount of Trisodium citrate dihydrate as a pH modifier.

The present invention also provides a method of treating a plant or soil against fungal infection comprising applying the aqueous fungicide mixture formulation disclosed herein to the plant, propagation material of the plant, or soil so as to thereby treat the plant or soil against fungal infection.

The present invention also provides use of the aqueous fungicide mixture formulation disclosed herein for combatting phytopathogenic diseases on crop plants and also for treating a plant or soil against fungal infection.

The present invention further provides use of the aqueous fungicide mixture formulation disclosed herein for controlling fungal pathogens such as Septoria tritici, Puccinia striiformis, Puccinia recondite, Rhyncosporium secalis, Ramularia collo-cygni, Pyrnte and Puccinia hordei, on cereals such as Wheat, Rye, Triticale and Barley.

The present invention also provides a process for the preparation of the aqueous fungicide mixture formulation disclosed herein from individual component parts.

The present invention further provides a method of controlling fungal disease comprising applying to the locus of the aqueous fungicide mixture formulation disclosed herein. The present invention also provides a method for controlling an apple scab disease comprising applying the aqueous fungicide mixture formulation, disclosed herein, to the plant, propagation material of the plant, and/or a locus of the plant. The present invention further provides a use of the aqueous fungicide mixture formulation, disclosed herein, for controlling an apple scab disease.

The present invention provides a method for controlling vegetable crops disease comprising applying the aqueous fungicide mixture formulation, disclosed herein, to the plant, propagation material of the plant, and/or a locus of the plant. The present invention further provides a use of the aqueous fungicide mixture formulation, disclosed herein, for controlling vegetable crops disease.

The present invention provides a method for controlling Early blight disease in potatoes, comprising applying the aqueous fungicide mixture formulation, disclosed herein, to the plant, propagation material of the plant, or a locus of the plant.

The present invention provides a method for controlling Early blight disease in tomato, comprising applying the aqueous fungicide mixture formulation, disclosed herein, to the plant, propagation material of the plant, and/or a locus of the plant.

The present invention also provides a method for controlling Sheath blight disease in rice, comprising applying the aqueous fungicide mixture formulation, disclosed herein, to the plant, propagation material of the plant, and/or a locus of the plant.

The present invention provides a method for controlling anthracnose disease in chilli, comprising applying the aqueous fungicide mixture formulation, disclosed herein, to the plant, propagation material of the plant, and/or a locus of the plant.

The present invention also relates to a use of the aqueous fungicide mixture formulation, disclosed herein, for protecting and prolonging the lifespan of medium to high resistance risk fungicides. The present invention also relates to a method of protecting and prolonging the lifespan of medium to high resistance risk fungicides comprising applying to the plant, propagation material of the plant, and/or a locus of the plant the aqueous fungicide mixture formulation, disclosed herein.

### DETAILED DESCRIPTION OF THE PRESENT SUBJECT MATTER

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

Reference will now be made in detail to embodiments, examples of which are illustrated in the accompanying tables, wherein like reference numerals refer to like elements throughout. In this regard, the present embodiments may have different forms and should not be construed as being limited to the descriptions set forth herein. Accordingly, the embodiments are merely described below to explain aspects of the present disclosure.

As used herein, the term “pesticide” broadly refers to an agent that can be used to control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein, the term “mixture” means but is not limited to an assemblage of agrochemicals for application either by simultaneous, contemporaneous and/or succession application. A combination in any time of application of the individual components e.g. succession and/or in any physical form, e.g. blend, solution, suspension, dispersion, emulsion, alloy, or the like. Mixture also may refer to combining and applying the active components as one composition and/or formulating each of the active component in the mixture or combination as separated compositions and application at the same time or in separated applications at the same time or different times.

The admixture or individual components may be in any physical form, e.g. blend, solution, suspension, dispersion, emulsion, alloy, or the like.

As used herein, the term “fungicidally effective amount” refers to an amount of the active component that is commercially recommended for use to control fungi. The commercially recommended amount for each active component, often specified as application rates of the commercial formulation, may be found on the label accompanying the commercial formulation. The commercially recommended application rates of the commercial formulation may vary depending on factors such as the plant species and the fungus to be controlled.

As used herein, the term “treating a plant or soil against fungal infection” includes, but is not limited to, protecting the plant or soil against fungal attack, preventing fungal infection of the plant or soil, controlling fungal disease infecting the plant or soil, and reducing fungal infection of the plant or soil.

As used herein, the term “more effective” includes, but is not limited to, increasing efficacy of fungal disease control, prolonging protection and reducing the amount of time needed to achieve a given level of fungal control, prolonging the duration of protection against fungal attack after application and extending the protection period against fungal attack and/or reducing the amount of time needed to achieve a level of fungal control compared to the fungicide formulation without suitable inert components therein. In particular, “more effective” includes increasing efficacy of fungal disease control in an untreated area.

As used herein, the term “effective” when used in connection with any mixture or formulation may be but is not limited to increase in controlling fungal disease, increase in preventing fungal disease, decrease time for effective controlling fungal disease, decrease the amount of the fungicide(s) which is required for effective controlling fungal disease, extend the controlling effect of the individual fungicide in the mixture in terms of type of crop and disease, prolong the time of controlling effect of the mixture compared to the individual fungicide in the mixture in terms of type of crop and disease, prolong the time of controlling effect of the individual fungicide in the mixture in terms of type of crop and disease. In particular, the term “effective” may refer to, increasing efficacy of fungal disease control in untreated plant area, reducing the amount of time needed to achieve a given level of fungal control, extending the protection period against fungal attack and/or reducing the amount of time needed to achieve a level of fungal control.

As used herein, the term “effective amount” refers to an amount of the agrochemical composition or of the mixture which is sufficient for controlling harmful fungi on crop plants and does not cause any significant damage to the treated crop plants.

As used herein, the term “agriculturally acceptable carrier” means carriers which are known and accepted in the art for the formation of compositions for agricultural or horticultural use.

As used herein, the term “inert components” or “coformulants” is defined as any substance that itself is not an active ingredient but is added to the composition or formulation such as additives, thickening agent, sticking agents, surfactants, anti-oxidation agent, anti-foaming agents and thickeners.

As used herein the term “plant” or “crop” includes reference to agricultural crops including field crops (soybean, maize, wheat, rice, etc.), vegetable crops (potatoes, cabbages, etc.), fruits (peach, etc.), semi-perennial crops (sugarcane) and perennial crops (coffee and guava).

As used herein the term “plant” or “crop” includes reference to whole plants, plant organs (e.g. leaves, stems, twigs, roots, trunks, limbs, shoots, fruits etc.), plant cells, seedling or plant seeds. This term also encompasses plant crops such as fruits.

The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts, basal shoots, stolons, and buds and other parts of plants, including seedlings and young plants, which are to be transplanted after germination, rooting or after emergence from soil or any other kind of substrate, be it artificial or natural.

As used herein the term “propagation material” is to be understood to denote all the generative parts of the plant such as seeds and spores, vegetative structures such as bulbs, corms, tubers, rhizomes, roots stems, basal shoots, stolons and buds.

As used herein, the term “locus” includes not only areas where fungal infection/disease may already be shown, but also areas where fungal infection/disease have yet to show and also area under cultivation. Locus include but is not limited to soil and other plant growth medium.

As used herein, the term “locus” includes a habitat, breeding ground, plant, propagation material, soil, area, material or environment in which a fungal disease is growing or may grow.

As used herein, the terms “control” or “controlling” or “treating” refers but is not limited to preventing fungal disease, protecting plants from fungal disease, delaying the onset of fungal disease, and combating or killing fungal disease. They also may include the curative and/or eradication action of compounds and compositions on underway fungal diseases. Controlling fungal disease infecting the plant, propagation material of the plant or locus of the plant, controlling a plant or soil disease caused by phytopathologic fungi (pathogen), controlling fungal attack on the plant or, propagation material of the plant or locus of the plant refers to curative application and/or protectant/preventive application and/or persistence application.

The term “applying” or “application”, as used herein, refers but is not limited to applying the compounds and compositions of the invention to the plant, to a site of infestation by fungi, to a potential site of infestation by the fungi, which may require protection from infestation, or the environment around the habitat or potential habitat of the fungi. It also refers to the activity of compounds and compositions on plants and fungal tissues with which they come into contact. The application may be by methods described in the present invention such as by spraying, dipping, etc.

Throughout the application, descriptions of various embodiments the term “comprising” is used; however, it will be understood by one of skill in the art, that in some specific instances, an embodiment can alternatively be described using the language “consisting essentially of” or “consisting of.” The term “a” or “an” as used herein includes the singular and the plural, unless specifically stated otherwise. Therefore, the terms “a,” “an” or “at least one” can be used interchangeably in this application.

Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

As used herein, the term “and/or” includes any and all combinations of one or more of the associated listed items. Expressions such as “at least one of.” when preceding a list of elements, modify the entire list of elements and do not modify the individual elements of the list.

For purposes of better understanding the present teachings and in no way limiting the scope of the teachings, each numerical parameter should be construed in light of the number of reported significant digits and by applying ordinary rounding techniques. In this regard, used of the term “about” herein specifically includes ±10% from the indicated values in the range. In addition, the endpoints of all ranges directed to the same component or property herein are inclusive of the endpoints, are independently combinable, and include all intermediate points and ranges.

### Fungicide Mixture Formulations

There is always a perennial challenge to formulate an aqueous fungicide mixture composition comprising two or more hydrophobic actives, such as, a phthalimide fungicide with an additional fungicide such as a strobilurin fungicide or/and a triazole fungicide with suitable inert components or coformulants to arrive at a stable formulation through hydrophobic actives colocalization, thereby enhancing efficiency.

In this endeavor, the inventors have attempted several options to make a stable formulation comprising two or more hydrophobic actives, for example, a phthalimide fungicide such as folpet, and a strobilurin fungicide, such as Azoxystrobin. Several combinations of inert components or coformulants were tried, but that only led to unstable aqueous formulation with either phase separation or drop in viscosity or both.

For example, Synperionic 13/10 (nonionic ethoxylated primary branched C₁₃-alcohol surfactant), Soprophor 4D384 (wetting agent), Sodium phosphate anhydrous, Citric acid anhydrous and Hexamine were tried in combination to make the aqueous formulation. On the other hand, Soprophor 4D384 (ethoxylated tristyryl phenol sulphate ammonium), Ethylan NS 500 LQ (non-ionic alkyl end-capped alcohol ethoxylate surfactant), without buffer and hexamine were also tried in combination to make a stable aqueous formulation. However, these attempts were not successful owing to either phase separation or drop in viscosity or both.

After several experimentations, it is surprisingly found that the formation of clathrate hydrates of some amines such as hexamine, quaternary hexamine, urea, alkyl urea, alkyl amine, polyamine, polyethylenimine, alkylamide, sugar amide, in presence of a non-ionic ethoxylate surfactant, with the aid of a pH modifier leads to a stable aqueous fungicide mixture formulation, which results in hydrophobic actives colocalization, thereby enhancing efficiency.

In an embodiment, the present invention provides an aqueous fungicide mixture formulation comprising (a) an effective amount of a phthalimide fungicide selected from the group consisting of folpet, captan and any combination thereof; (b) an effective amount of an additional fungicide selected from the group comprising a strobilurin fungicide, a triazole fungicide and any combination thereof; (c) an effective amount of a non-ionic surfactant; (d) an effective amount of an amine capable of forming clathrate hydrates; and (e) an effective amount of a pH modifier.

In an embodiment, the present invention provides an aqueous fungicide mixture formulation comprising (a) an effective amount of a phthalimide fungicide selected from the group consisting of folpet, captan and any combination thereof; (b) an effective amount of an additional fungicide selected from the group comprising a strobilurin fungicide, a triazole fungicide and any combination thereof; (c) an effective amount of a non-ionic surfactant; (d) an effective amount of an amine capable of forming clathrate hydrates; and (e) an effective amount of a pH modifier, wherein the phthalimide fungicide and the additional fungicide are present in the ratio ranges from 10:1 to 1:10.

In some embodiment, the present invention provides an aqueous fungicide mixture formulation comprising (a) an effective amount of a phthalimide fungicide selected from the group consisting of folpet, captan and any combination thereof; (b) an effective amount of an additional fungicide selected from the group comprising a strobilurin fungicide, a triazole fungicide and any combination thereof; (c) an effective amount of a non-ionic surfactant; (d) an effective amount of an amine capable of forming clathrate hydrates; and (e) an effective amount of a pH modifier; and agriculturally acceptable carriers, such as a stabilizer, a wetting agent, a defoamer, an anti-freezing agent, a biocide, a defoamer and a rheology modifier.

In an embodiment, the present invention provides an aqueous fungicide mixture formulation comprising (a) an effective amount of a phthalimide fungicide selected from the group consisting of folpet, captan and any combination thereof; (b) an effective amount of an additional fungicide selected from the group comprising a strobilurin fungicide, a triazole fungicide and any combination thereof; (c) an effective amount of a non-ionic surfactant selected from a group comprising an alkyl end-capped alcohol ethoxylate, a fatty-amide ethoxylate, a sugar amide ethoxylate; (d) an effective amount of an amine capable of forming clathrate hydrates selected from a group comprising hexamine, quaternary hexamine, urea, alkyl urea, amine, polyamine, polyethylenimine, alkylamide and a sugar amide; and (e) an effective amount of a pH modifier.

In an embodiment, the present invention provides an aqueous fungicide mixture formulation comprising (a) an effective amount of a phthalimide fungicide selected from the group consisting of folpet, captan and any combination thereof; (b) an effective amount of an additional fungicide selected from the group comprising a strobilurin fungicide, a triazole fungicide and any combination thereof; (c) an effective amount of a non-ionic surfactant selected from a group comprising ethoxylates comprising Ethylan NS 500 LQ, Genapol XM060, Genapol XM150, Poly(ethylene glycol) monolauramide, Amidox L5, Glucamide ethoxylate, Oleyl methyl glucamide ethoxylate and Gluconamide ethoxylate; (d) an effective amount of an amine capable of forming clathrate hydrates selected from a group comprising hexamine, urea, methyl urea, ethyl urea, ethylamine, butylamine, lysine, polylysine, spermidine, spermine, N-octyl gluconamide, N-oleyl gluconamide; Glucamide, N-alkyl glucamide, cocoyl methyl glucamide, Lauroyl methyl glucamide, GlucoTain Plus and GlucoTain Care; and (c) an effective amount of a pH modifier.

In another embodiment, the present invention also provides an aqueous fungicide mixture formulation comprising (a) an effective amount of a phthalimide fungicide selected from the group consisting of folpet, captan and any combination thereof; (b) an effective amount of triazole fungicide selected from the group comprising tebuconazole, prothioconazole and difenoconazole; (c) an effective amount of a non-ionic surfactant; (d) an effective amount of an amine capable of forming clathrate hydrates; and (c) an effective amount of a pH modifier.

In another embodiment, the present invention also provides an aqueous fungicide mixture formulation comprising (a) an effective amount of a phthalimide fungicide selected from the group consisting of folpet, captan and any combination thereof; (b) an effective amount of triazole fungicide selected from the group comprising tebuconazole, prothioconazole and difenoconazole; (c) an effective amount of a non-ionic surfactant; (d) an effective amount of an amine capable of forming clathrate hydrates; and (c) an effective amount of a pH modifier, wherein phthalimide fungicide and the strobilurin fungicide may be present in the ratio ranges from 10:1 to 1:10.

In another embodiment, the present invention also provides an aqueous fungicide mixture formulation comprising (a) an effective amount of a phthalimide fungicide selected from the group consisting of folpet, captan and any combination thereof; (b) an effective amount of a strobilurin fungicide selected from the group comprising azoxystrobin, pyraclostrobin and picoxystrobin; (c) an effective amount of a non-ionic surfactant; (d) an effective amount of an amine capable of forming clathrate hydrates; and (e) an effective amount of a pH modifier.

In another embodiment, the present invention also provides an aqueous fungicide mixture formulation comprising (a) an effective amount of a phthalimide fungicide selected from the group consisting of folpet, captan and any combination thereof; (b) an effective amount of a strobilurin fungicide selected from the group comprising azoxystrobin, pyraclostrobin and picoxystrobin; (c) an effective amount of a non-ionic surfactant; (d) an effective amount of an amine capable of forming clathrate hydrates; and (e) an effective amount of a pH modifier, wherein phthalimide fungicide and the strobilurin fungicide may be present in the ratio ranges from 10:1 to 1:10.

In an embodiment, the present invention also provides an aqueous fungicide mixture formulation comprising (a) an effective amount of folpet; (b) an effective amount of azoxystrobin; (c) an effective amount of a non-ionic surfactant; (d) an effective amount of an amine capable of forming clathrate hydrates; and (c) an effective amount of a pH modifier; and agriculturally acceptable carriers, such as a stabilizer, a wetting agent, a defoamer, an anti-freezing agent, a biocide, a defoamer and a rheology modifier.

In some embodiment, the present invention also provides an aqueous fungicide mixture formulation comprising (a) an effective amount of folpet; (b) an effective amount of azoxystrobin; (c) an effective amount of a non-ionic alkyl end-capped alcohol ethoxylate surfactant; (d) an effective amount of an amine capable of forming clathrate hydrates; and (c) an effective amount of a pH modifier which is either Trisodium citrate dihydrate or disodium hydrogen phosphate

In a specific embodiment, the present invention also provides an aqueous fungicide mixture formulation comprising (a) an effective amount of folpet; (b) an effective amount of azoxystrobin; (c) an effective amount of Ethylan NS 500 LQ surfactant; (d) an effective amount of hexamine; and (e) an effective amount of Trisodium citrate dihydrate as a pH modifier.

In another embodiment, the present invention also provides an aqueous fungicide mixture formulation comprising (a) an effective amount of folpet; (b) an effective amount of tebuconazole; (c) an effective amount of a non-ionic surfactant; (d) an effective amount of an amine capable of forming clathrate hydrates; and (e) an effective amount of a pH modifier; and agriculturally acceptable carriers, such as a stabilizer, a wetting agent, a defoamer, an anti-freezing agent, a biocide, a defoamer and a rheology modifier.

In a further embodiment, the present invention also provides an aqueous fungicide mixture formulation comprising (a) an effective amount of folpet; (b) an effective amount of pyraclostrobin; (c) an effective amount of a non-ionic surfactant; (d) an effective amount of an amine capable of forming clathrate hydrates; and (c) an effective amount of a pH modifier; and agriculturally acceptable carriers, such as a stabilizer, a wetting agent, a defoamer, an anti-freezing agent, a biocide, a defoamer and a rheology modifier.

In an embodiment, present invention also provides a method of treating a plant or soil against fungal infection comprising applying the aqueous fungicide mixture formulation disclosed herein to the plant, propagation material of the plant, or soil so as to thereby treat the plant or soil against fungal infection.

In an embodiment, present invention also provides use of the aqueous fungicide mixture formulation disclosed herein for combatting phytopathogenic diseases on crop plants and also for treating a plant or soil against fungal infection.

In another embodiment, present invention provides use of the aqueous fungicide mixture formulation disclosed herein for controlling fungal pathogens such as Septoria tritici, Puccinia striiformis, Puccinia recondite, Rhyncosporium secalis, Ramularia collo-cygni, Pyrnte and Puccinia hordei, on cereals such as Wheat, Rye, Triticale and Barley.

In an embodiment, present invention also provides a process for the preparation of the aqueous fungicide mixture formulation disclosed herein from individual component parts.

In an embodiment, present invention further provides a method of controlling fungal disease comprising applying to the locus of the aqueous fungicide mixture formulation disclosed herein. The present invention also provides a method for controlling an apple scab disease comprising applying the aqueous fungicide mixture formulation, disclosed herein, to the plant, propagation material of the plant, and/or a locus of the plant. The present invention further provides a use of the aqueous fungicide mixture formulation, disclosed herein, for controlling an apple scab disease.

In an embodiment, present invention provides a method for controlling vegetable crops disease comprising applying the aqueous fungicide mixture formulation, disclosed herein, to the plant, propagation material of the plant, and/or a locus of the plant. The present invention further provides a use of the aqueous fungicide mixture formulation, disclosed herein, for controlling vegetable crops disease.

In an embodiment, present invention provides a method for controlling Early blight disease in potatoes, comprising applying the aqueous fungicide mixture formulation, disclosed herein, to the plant, propagation material of the plant, or a locus of the plant.

In an embodiment, present invention provides a method for controlling Early blight disease in tomato, comprising applying the aqueous fungicide mixture formulation, disclosed herein, to the plant, propagation material of the plant, and/or a locus of the plant.

In another embodiment, present invention also provides a method for controlling Sheath blight disease in rice, comprising applying the aqueous fungicide mixture formulation, disclosed herein, to the plant, propagation material of the plant, and/or a locus of the plant.

In an embodiment, present invention provides a method for controlling anthracnose disease in chilli, comprising applying the aqueous fungicide mixture formulation, disclosed herein, to the plant, propagation material of the plant, and/or a locus of the plant.

In further embodiment, present invention also relates to a use of the aqueous fungicide mixture formulation, disclosed herein, for protecting and prolonging the lifespan of medium to high resistance risk fungicides. The present invention also relates to a method of protecting and prolonging the lifespan of medium to high resistance risk fungicides comprising applying to the plant, propagation material of the plant, and/or a locus of the plant the aqueous fungicide mixture formulation, disclosed herein.

The following examples illustrate the practice of the present invention in some of its embodiments but should not be construed as limiting the scope of the invention. Other embodiments will be apparent to one skilled in the art from consideration of the specification and examples. It is intended that the specification, including the examples, is considered exemplary only without limiting the scope and spirit of the invention.

### Preparatory Examples

### Formulation

One exemplary embodiment of the formulation of the present invention is illustrated in the below Table 1:

TABLE 1

| S. | | | | w/v |
|---|---|---|---|---|
| No | Ingredient | Function | w/w | [g/L] |
| 1 | Azoxystrobin tech. (100% | Active ingredient | 6.15 | 75.00 |
| | active basis) | | | |
| 2 | Folpet tech.(100% active | Active ingredient | 30.74 | 375.00 |
| | basis) | | | |
| 3 | Soprophor 4D384 | Dispersant | 2.00 | 24.40 |
| 4 | Ethylan NS 500 LQ | Wetting agent | 1.00 | 12.20 |
| 5 | Propylene glycol | Antifreeze | 5.50 | 67.10 |
| 6 | Trisodium citrate dihydrate | Buffer | 2.50 | 30.50 |
| 7 | Hexamine | Stabilizer | 0.80 | 9.76 |
| 8 | Vangel B | Stabilizer | 0.75 | 9.15 |
| 9 | SAG 1572 | Antifoam | 0.50 | 6.10 |
| 10 | Proxel GXL | Biocide | 0.16 | 1.95 |
| 11 | Kelazan AP-AS | Viscosity modifier | 0.20 | 2.44 |
| 12 | Water | Filler | QS | QS to |
| | | | to 100 | 1 litre |
| | Total | | 100.00 | 1220.00 |
| | | | | (1 litre) |

The formulation was prepared by following below procedures:
1. Premix preparation and milling: A required quantity of soft water is charged to the reactor, followed by adding Vangel B gradually to the reactor while mixing, and the suspension was put under high shear until it was homogeneous. Soprophor4D384, Ethylan NS 500 LQ, SAG 1572 (50% of the total quantity), Propylene glycol, Proxel GXL and Trisodium citrate dihydrate were also added gradually to the reactor, and the suspension was mixed until it was homogeneous. Thereafter, the actives, Folpet and Azoxystrobin were added slowly to the slurry, and were put under high shear until the suspension was homogeneous. The suspension was milled to a bead mill (Beads Size: approx. 1.2 mm) until the particle size is D90<8 microns. To this suspension, Hexamine and remaining quantity of the SAG 1572 (50% of the total quantity) were charged and mixed well until the suspension was made homogeneous.
2. Preparation of Gel: Kelzan AP-AS (2%): 0.01 part of Proxel GXL was added to 92.99 part of soft water and was mixed well. On the other hand, 2 parts Kelazan AP-AS was dispersed in 5 parts of propylene glycol. Thereafter, the slurry of Kelzan AP-AS & Propylene Glycol was added to the water with vigorous stirring. This slurry was mixed until homogeneous gel was formed.
3. Preparation of the Formulation: To the suspension of procedure (1), Kelzan AP-AS (2%) gel solution of procedure (2) was added while mixing. The mixing was continued until the suspension was made homogeneous, and the desired formulation is obtained.

The present invention relates to an aqueous fungicide mixture formulation that exhibits good chemical and physical stability under normal storage conditions and also shows improved dispersibility in water and having very efficient colocalizations of two or more hydrophobic actives. Chemical and physical stability is commonly considered to be “good” if the formulation passes the following CIPAC test that is standard in the relevant industry before and after storage stability test (2 week at 54° C. or equivalent—after 8 week at 40° C.):
1. Active ingredient (AI) concentration is stable according to the acceptable values in the industry (for example above concentration of 50% AI±25 gr/kg of the declared content);
2. Persistent foam<60 ml after 1 minute;
3. MT 185—Wet sieve test<1% residue
4. Suspensibility>60%;
5. PSD, D90<10μ

Normal storage condition is two years storage at room temperature or under accelerated storage stability test: after 2 weeks at 54° C. or equivalent—after 8 weeks at 40° C. or after 12 weeks at 35° C.

Another exemplary embodiment of the formulation (composition A) of the present invention is illustrated in the below Table 2:

TABLE 2

| S. | | | | w/v |
|---|---|---|---|---|
| No | Ingredient (Composition A) | Function | w/w | [g/L] |
| 1 | Azoxystrobin tech. | Active ingredient | 6.4 | 78.08 |
| | (98% A.I) | | | |
| 2 | Folpet tech. (95% A.I) | Active ingredient | 33.0 | 402.6 |
| 3 | Soprophor 4D384 | Dispersant | 2.00 | 24.40 |
| 4 | Ethylan NS 500 LQ | Wetting agent | 1.00 | 12.20 |
| 5 | Propylene glycol | Antifreeze | 5.50 | 67.10 |
| 6 | Trisodium citrate dihydrate | Buffer | 2.50 | 30.50 |
| 7 | Hexamine | Stabilizer | 0.80 | 9.76 |
| 8 | Vangel B | Stabilizer | 0.75 | 9.15 |
| 9 | SAG 1572 | Antifoam | 0.50 | 6.10 |
| 10 | Proxel GXL | Biocide | 0.16 | 1.95 |
| 11 | Kelazan AP-AS | Viscosity modifier | 0.20 | 2.44 |
| 12 | Water | Filler | QS | QS to |
| | | | to 100 | 1 litre |
| | Total | | 100.00 | 1220.00 |
| | | | | (1 litre) |

The physicochemical analytical results of different batches of composition A are illustrated below.

TABLE 2A
Analytical results:

| Batch 1, (Composition A) | | Initial | 54° C.-14 days |
|---|---|---|---|
| | | Creamy | No colour |
| | | viscous | change and |
| | | liquid | 1% separation |
| Active Content | Azoxystrobin, g/l | 78.4 | 78.3 |
| | Folpet, g/l | 385.2 | 377.5 |
| pH Neat | | 6.88 | 4.34 |
| Suspensibility, % | Azoxystrobin | 98.7 | 95.6 |
| w/w | Folpet | 99.1 | 95.9 |
| Spontaneity of | Azoxystrobin | 96.4 | 98.6 |
| dispersion, % w/w | Folpet | 96.1 | 98.3 |

| | | |
|---|---|---|
| Wet sieve residue on 75 Micron sieve | <0.1 | <0.1 |
| Persistent foam (in ml) after 1 minute | Nil | Nil |
| Pourability, (% w/w)/ | 5.50/0.29 | — |
| rinsed residue, (% w/w) | | |
| Particle size (D90), micron | 5.53 | 6.29 |
| Density (g/cc at 25° C.) | 1.22 | |
| Viscosity 62 spindle, 12 rpm, cP | 1990 | 1670 |

| | |
|---|---|
| Cold stability at 0° C., 7 days | Flowable |

TABLE 2B
Analytical results:

| Batch 2 (Composition A) | | Composition A | | |
|---|---|---|---|---|
| Tests | | 0 day | RT-14 days | 54 C.-14 days |
| Appearance | | Creamy | Creamy | 1% separation |
| | | viscous liquid | viscous liquid, | and no colour |
| | | | No separation | change |
| Active Content | Azoxystrobin, g/l | 76.738 | 76.25 | 76.86 |
| | Folpet, g/l | 377.102 | 357.094 | 374.784 |
| pH Neat | | 6.32 | 6.01 | 4.05 |
| Suspensibility, % | Azoxystrobin | 99.58 | — | 94.59 |
| w/w | Folpet | 99.34 | — | 96.43 |
| Spontaneity of | Azoxystrobin | 96.33 | — | 96.55 |
| dispersion, % w/w | Folpet | 96.63 | — | 97.06 |

| Wet sieve residue on 75 Micron sieve | Nil | Nil | Nil |
|---|---|---|---|
| Persistent foam (in ml) after 1 minute | Nil | Nil | Nil |
| Particle size (D90), micron | 3.047 | 3.24 | 4.42 |
| Density (g/cc at 25° C.) | 1.22 | | |
| Viscosity 62 spindle, 12 rpm, cP | 1850 | 1770 | 1690 |

| | |
|---|---|
| Cold stability at 0° C., 7 days | Flowable |

The comparative examples of the similar formulation as in Table 1 and 2 without some critical ingredients (a non-ionic surfactant; an amine capable of forming clathrate hydrates; and a pH modifier) were also prepared as in Table 3 below:

TABLE 3

| | | Composition B | |
|---|---|---|---|
| No. | Ingredients | % w/w | g/L |
| 1 | Azoxystrobin tech. (98.4% A.I) | 6.34 | 77.37 |
| 2 | Folpet tech. (95.2% A.I) | 32.77 | 399.83 |
| 3 | Soprophor 4D384 | 2.00 | 24.40 |
| 4 | Ethylan NS 500 LQ | 0.00 | 0.00 |
| 5 | Propylene glycol | 5.50 | 67.10 |
| 6 | Trisodium citrate dihydrate | 0.00 | 0.00 |
| 7 | Hexamine | 0.00 | 0.00 |
| 8 | Vangel B | 0.75 | 9.15 |
| 9 | SAG 1572 | 0.50 | 6.10 |
| 10 | Proxel GXL | 0.16 | 1.95 |
| 11 | Kelazan AP-AS | 0.20 | 2.44 |
| 12 | Water | QS to 100 | QS to 1 litre |
| | Total | 100.00 | 1220.00 (1 litre) |

The physicochemical analytical results of formulation as in Table 3 is illustrated below in Table 4:

TABLE 4
Analytical results:

| | | for Composition B | | |
|---|---|---|---|---|
| Parameter | | Initial | RT-14 days | 54 C.-14 days |
| Appearance | | Creamy | No separation, no | Colour changed |
| | | viscous | colour change, | to yellow with |
| | | liquid | Viscosity increased | 5% separation |
| Active Content | Azoxystrobin, g/l | 83.69 | 78.08 | 70.52 |
| | Folpet, g/l | 414.56 | 386.98 | 380.52 |
| pH Neat | | 2.39 | 2.09 | 1.26 |
| Suspensibility, | Azoxystrobin | 99.97 | — | 88.53 |
| % w/w | Folpet | 100.17 | — | 91.39 |
| Spontaneity of | Azoxystrobin | 95.13 | — | 94.25 |
| dispersion, % w/w | Folpet | 96.01 | — | 94.93 |

| Wet sieve residue on 75 Micron sieve | Nil | Nil | Nil |
|---|---|---|---|
| Persistent foam (in ml) after 1 minute | Nil | Nil | Nil |
| Particle size (D90), micron | 4.76 | 4.69 | 7.03 |
| Density (g/cc at 25° C.) | 1.22 | | |
| Viscosity 62 spindle, 12 rpm, cP | 1515 | >2500 | 1440 |

| | |
|---|---|
| Cold stability at 0° C., 7 days | Flowable |

Furthermore, the comparative examples of the similar formulation as in Table 1 and 2 without some critical ingredients (an amine capable of forming clathrate hydrates: and a pH modifier) were also prepared as in Table 5 below:

TABLE 5

| | | Composition C | |
|---|---|---|---|
| No. | Ingredients | % w/w | g/L |
| 1 | Azoxystrobin tech. (98.4% A.I) | 6.34 | 77.37 |
| 2 | Folpet tech. (95.2% A.I) | 32.77 | 399.83 |
| 3 | Soprophor 4D384 | 2.00 | 24.40 |
| 4 | Ethylan NS 500 LQ | 1.00 | 12.20 |
| 5 | Propylene glycol | 5.50 | 67.10 |
| 6 | Trisodium citrate dihydrate | 0.00 | 0.00 |
| 7 | Hexamine | 0.00 | 0.00 |
| 8 | Vangel B | 0.75 | 9.15 |
| 9 | SAG 1572 | 0.50 | 6.10 |
| 10 | Proxel GXL | 0.16 | 1.95 |
| 11 | Kelazan AP-AS | 0.20 | 2.44 |
| 12 | Water | QS to 100 | QS to 1 litre |
| | Total | 100.00 | 1220.00 (1 litre) |

The physicochemical analytical results of formulation as in Table 5 is illustrated below in Table 6:

TABLE 6
Analytical results:

| | | for Composition C | | |
|---|---|---|---|---|
| Parameter | | Initial | RT-14 days | 54 C.-14 days |
| Appearance | | Creamy viscous | No separation, no | Colour changed |
| | | liquid | colour change, | to yellow with |
| | | | Viscosity | 10% separation |
| | | | increased | |
| Active Content | Azoxystrobin, g/l | 78.32 | 77.23 | 71.86 |
| | Folpet, g/l | 390.28 | 381.74 | 373.93 |
| PH Neat | | 2.34 | 2.15 | 1.19 |
| Suspensibility, % | Azoxystrobin | 98.57 | — | 79.03 |
| w/w | Folpet | 98.55 | — | 84.04 |
| Spontaneity of | Azoxystrobin | 97.23 | — | 91.73 |
| dispersion, % w/w | Folpet | 98.52 | — | 92.66 |

| Wet sieve residue on 75 Micron sieve | Nil | Nil | Nil |
|---|---|---|---|
| Persistent foam (in ml) after 1 minute | Nil | Nil | Nil |
| Particle size (D90), micron | 4.78 | 4.81 | 6.95 |
| Density (g/cc at 25° C.) | 1.22 | | |
| Viscosity 62 spindle, 12 rpm, cP | 2095 | >2500 | 2125 |

| | |
|---|---|
| Cold stability at 0° C., 7 days | Flowable |

Conclusion: From the above formulation recipes (Inventive recipes in Table 1 and 2, as well as comparative examples in Table 3 and 5) and their analytical results, it is clearly exhibited that some critical ingredients (e.g. a non-ionic surfactant, an amine capable of forming clathrate hydrates; and a pH modifier) are essential to the stability of the composition of the present invention.

Furthermore, some other compositions of the present invention were also prepared as in Table 7 and 9. The stability data of the same were also exhibited in Table 8 and 10, respectively.

TABLE 7

| | | Composition D | |
|---|---|---|---|
| No. | Ingredients | % w/w | g/L |
| 1 | Folpet tech.(95% A.I) | 33.00 | 402.60 |
| 2 | Tebuconazole tech. (98% A.I) | 6.43 | 78.45 |
| 3 | Soprophor 4D384 | 2.00 | 24.40 |
| 4 | Ethylan NS 500 LQ | 1.00 | 12.20 |
| 5 | Propylene glycol | 5.50 | 67.10 |
| 6 | Trisodium citrate dihydrate | 2.50 | 30.50 |
| 7 | Hexamine | 0.80 | 9.76 |
| 8 | Vangel B | 0.75 | 9.15 |
| 9 | SAG 1572 | 0.50 | 6.10 |
| 10 | Proxel GXL | 0.16 | 1.95 |
| 11 | Kelazan AP-AS | 0.22 | 2.68 |
| 12 | Water | QS to 100 | QS to 1 litre |
| | Total | 100.00 | 1220.00 (1 litre) |

TABLE 8
Analytical results:

| | | for Composition D | | |
|---|---|---|---|---|
| Parameter | | Initial | RT-14 days | 54° C.-14 days |
| Appearance | | Creamy | Creamy | 1% separation, |
| | | viscous | viscous liquid, | no colour |
| | | liquid | no separation | change |
| Active Content | Folpet, g/l | 374.66 | 367.342 | 351.33 |
| | Tebuconazole. g/l | 75.76 | 76.25 | 74.42 |
| pH Neat | | 7.03 | 6.13 | 3.97 |
| Suspensibility, | Tebuconazole | 95.82 | 97.29 | 84.82 |
| % w/w | Folpet | 98.38 | 98.73 | 97.12 |
| Spontaneity of | Tebuconazole | 98.43 | 98.58 | 97.41 |
| dispersion, % w/w | Folpet | 101.83 | 101.39 | 100.96 |

| | | | |
|---|---|---|---|
| Wet sieve residue on 75 Micron sieve | Nil | Nil | Nil |
| Persistent foam (in ml) after 1 minute | 0 | 0 | 0 |
| Particle size (D90), micron | 3.667 | 3.82 | 7.52 |
| Density (g/cc at 25° C.) | 1.226 | — | — |
| Viscosity 62 spindle, 12 rpm, cP | 2010 | 2205 | 2123 |

| | |
|---|---|
| Cold stability at 0° C., 7 days | Flowable |

TABLE 9

| | | Composition E | |
|---|---|---|---|
| No. | Ingredients | % w/w | g/L |
| 1 | Folpet tech.(95% A.I) | 33.00 | 402.60 |
| 2 | Pyraclostrobin tech. (98.2% A.I) | 6.42 | 78.32 |
| 3 | Soprophor 4D384 | 2.00 | 24.40 |
| 4 | Ethylan NS 500 LQ | 1.00 | 12.20 |
| 5 | Propylene glycol | 5.50 | 67.10 |
| 6 | Trisodium citrate dihydrate | 2.50 | 30.50 |
| 7 | Hexamine | 0.80 | 9.76 |
| 8 | Vangel B | 0.75 | 9.15 |
| 9 | SAG 1572 | 0.50 | 6.10 |
| 10 | Proxel GXL | 0.16 | 1.95 |
| 11 | Kelazan AP-AS | 0.22 | 2.68 |
| 12 | Water | QS to 100 | QS to 1 litre |
| | Total | 100.00 | 1220.00 (1 litre) |

TABLE 10
Analytical results:

| | | for Composition E | | |
|---|---|---|---|---|
| Parameter | | Initial | RT-14 days | 54° C.-14 days |
| Appearance | | Creamy | Creamy viscous | 2% separation, |
| | | viscous | liquid, no | no colour |
| | | liquid | separation | change |
| Active Content | Folpet, g/l | 383.02 | 385.359 | 371.09 |
| | Pyraclostrobin, g/l | 77.12 | 76.752 | 77.00 |
| pH Neat | | 7.01 | 6.17 | 3.86 |
| Suspensibility, % | Pyraclostrobin | 96.89 | 97.19 | 99.79 |
| w/w | Folpet | 97.8 | 97.78 | 98.05 |
| Spontaneity of | Pyraclostrobin | 99.02 | 97.53 | 99.24 |
| dispersion, % w/w | Folpet | 98.74 | 97.38 | 98.69 |

| | | | |
|---|---|---|---|
| Wet sieve residue on 75 Micron sieve | Nil | Nil | Nil |
| Persistent foam (in ml) after 1 minute | 0 | 0 | 0 |
| Particle size (D90), micron | 4.049 | 4.122 | 4.519 |
| Density (g/cc at 25° C.) | 1.236 | — | — |
| Viscosity 62 spindle, 12 rpm, cP | 2125 | 2080 | 1120 |

| | |
|---|---|
| Cold stability at 0° C., 7 days | Flowable |

What is claimed is:

1. An aqueous fungicide mixture formulation comprising
(a) an effective amount of a phthalimide fungicide selected from the group consisting of folpet, captan and any combination thereof;
(b) an effective amount of an additional fungicide selected from the group comprising a strobilurin fungicide, a triazole fungicide and any combination thereof;
(c) an effective amount of a non-ionic surfactant;
(d) an effective amount of an amine capable of forming clathrate hydrates; and
(e) an effective amount of a pH modifier.

2. The aqueous fungicide mixture formulation of claim 1, wherein the phthalimide fungicide and the additional fungicide is present in the ratio ranges from 10:1 to 1:10.

3. The aqueous fungicide mixture formulation of any one of claims 1-2 further comprising agriculturally acceptable carriers, which are selected from a group comprising a stabilizer, a wetting agent, a defoamer, an anti-freezing agent, a biocide, a rheology modifier and any combination thereof.

4. The aqueous fungicide mixture formulation of any one of claims 1-3, wherein the strobilurin fungicide is selected from the group comprising azoxystrobin, pyraclostrobin and picoxystrobin.

5. The aqueous fungicide mixture formulation of any one of claims 1-3, wherein the triazole fungicide is selected from the group comprising tebuconazole, prothioconazole and difenoconazole.

6. The aqueous fungicide mixture formulation of any one of claims 1-3, wherein the phthalimide fungicide is folpet, and additional fungicide is azoxystrobin.

7. The aqueous fungicide mixture formulation of any one of claims 1-3, wherein the phthalimide fungicide is folpet, and additional triazole fungicide is tebuconazole.

8. The aqueous fungicide mixture formulation of any one of claims 1-3, wherein the phthalimide fungicide is folpet, and additional strobilurin fungicide is pyraclostrobin.

9. The aqueous fungicide mixture formulation of any one of claims 1-3, wherein the non-ionic surfactant is selected from a group comprising an alkyl end-capped alcohol ethoxylate, a fatty-amide ethoxylate, a sugar amide ethoxylate.

10. The aqueous fungicide mixture formulation of claim 9, wherein the non-ionic surfactant is selected from a group of ethoxylates comprising Ethylan NS 500 LQ, Genapol XM060, Genapol XM150, Poly(ethylene glycol) monolauramide, Amidox L5, Glucamide ethoxylate, Oleyl methyl glucamide ethoxylate and Gluconamide ethoxylate.

11. The aqueous fungicide mixture formulation of claim 10, wherein the non-ionic surfactant is Ethylan NS 500 LQ.

12. The aqueous fungicide mixture formulation of any one of claims 1-3, wherein the amine capable of forming clathrate hydrates is selected from a group comprising hexamine, quaternary hexamine, urea, alkyl urea, amine, polyamine, polyethylenimine, alkylamide and a sugar amide.

13. The aqueous fungicide mixture formulation of claim 12, wherein the amine capable of forming clathrate hydrates is selected from a group of amines comprising hexamine, alkyl-substituted hexamine, urea, methyl urea, ethyl urea, ethylamine, butylamine, lysine, polylysine, spermidine, spermine, N-octyl gluconamide, N-oleyl gluconamide; Glucamide, N-alkyl glucamide, cocoyl methyl glucamide, Lauroyl methyl glucamide, GlucoTain Plus and GlucoTain Care.

14. The aqueous fungicide mixture formulation of claim 13, wherein the amine capable of forming clathrate hydrates is hexamine.

15. The aqueous fungicide mixture formulation of any one of claims 1-3, wherein the pH modifier is either Trisodium citrate dihydrate or disodium hydrogen phosphate.

16. The aqueous fungicide mixture formulation of claim 15, wherein the pH modifier is Trisodium citrate dihydrate.

17. A method of treating a plant or soil against fungal infection comprising applying the aqueous fungicide mixture formulation of any one of claims 1-3, to the plant, propagation material of the plant, or soil so as to thereby treat the plant or soil against fungal infection.

18. A method for controlling an apple scab disease comprising applying the aqueous fungicide mixture formulation of any one of claims 1-3, to the plant, propagation material of the plant, and/or a locus of the plant.

19. Use of the aqueous fungicide mixture formulation of any one of claims 1-3 for combatting phytopathogenic diseases on crop plants and also for treating a plant or soil against fungal infection.

20. The use of the aqueous fungicide mixture formulation of claim 19, for controlling fungal pathogens on cereals.

21. The use of the aqueous fungicide mixture formulation of claim 20, wherein fungal pathogens are selected from the species Septoria tritici, Puccinia striiformis, Puccinia recondite, Rhyncosporium secalis, Ramularia collo-cygni, Pyrnte and Puccinia hordei, and wherein the cereals are selected from Wheat, Rye, Triticale and Barley.

22. The use of the aqueous fungicide mixture formulation of claim 19, for controlling an apple scab disease.

23. The use of the aqueous fungicide mixture formulation of claim 19, for controlling vegetable crops disease.

24. A method for controlling Early blight disease in potatoes, comprising applying the aqueous fungicide mixture formulation of any one of claims 1-3, to the plant, propagation material of the plant, or a locus of the plant.

25. A method for controlling Early blight disease in tomato, comprising applying the aqueous fungicide mixture formulation of any one of claims 1-3, to the plant, propagation material of the plant, and/or a locus of the plant.

26. A method for controlling Sheath blight disease in rice, comprising applying the aqueous fungicide mixture formulation of any one of claims 1-3, to the plant, propagation material of the plant, and/or a locus of the plant.

27. A method for controlling anthracnose disease in chilli, comprising applying the aqueous fungicide mixture formulation of any one of claims 1-3, to the plant, propagation material of the plant, and/or a locus of the plant.

28. A method of protecting and prolonging the lifespan of medium to high resistance risk fungicides comprising applying to the plant, propagation material of the plant, and/or a locus of the plant the aqueous fungicide mixture formulation of any one of claims 1-3.
